(19) United States
(12) Patent Application Publication
(10) Pub. No.: US 2014/0375651 A1
(43) Pub. Date: Dec. 25, 2014

(54) METHOD FOR DISPLAYING USAGE OF COMPUTER RESOURCES AND DEVICE THEREFOR

(71) Applicant: BEIJING TEAMSUN TECHNOLOGY CO. LTD., Beijing (CN)

(72) Inventor: Dahai WANG, Beijing (CN)

(73) Assignee: BEIJING TEAMSUN TECHNOLOGY CO. LTD., Beijing (CN)

(21) Appl. No.: 14/144,817

(22) Filed: Dec. 31, 2013

(30) Foreign Application Priority Data
Jun. 24, 2013 (CN) 201310253139.2

(51) Int. Cl. G06T 11/20

(52) U.S. Cl. CPC G06T 11/206
USPC 345/440

(57) ABSTRACT

Provided are a method for displaying the usage of computer resources and a device therefor. The method includes: 1) constructing a rectangular coordinate system with the usage data of two computer resources as the horizontal and vertical axes, respectively; 2) drawing dots in the rectangular coordinate system using the simultaneously obtained usage data of the two computer resources as the coordinates and using colors for the dots determined by the sampling sequence; 3) when a user views the graph, he can approximately determine the usages of the two computer resources at a given time by observing the position of the dot, can approximately determine the duration between the time a given sample is taken and the current time by the color of the dot, and can approximately determine the typical usage state of the computer resources by observing the density of the dots in the graph.

### BACKGROUND OF THE INVENTION

1. Field of the Invention

The present invention relates to computer technical field, and more particularly, to a method for displaying the usage of computer resources and a device therefor. With the method, the usage of computer resources, such as the computer CPU, the memory, the network bandwidth, the disk channel width, etc., is displayed by means of graphs.

2. Description of the Related Art

The computer resources in the present description refer to the processing capacity of a CPU, the memory space, the maximum throughput capacity and the maximum input or output capacity of the network interface, and the maximum throughput capacity and the maximum input or output capacity of the disk channel, etc. It helps the computer user to visually understand the usage states of the computer resources by displaying the usage of computer recourse by means of graphs.

Conventional methods for displaying the usage of computer resources typically use the following: in the time domain, at each specific time interval, collecting and obtaining the usage data of the computer resources which includes the actual numbers or proportions and so on, and sequentially displaying the data in a rectangular coordinate system with time as the horizontal axis and the usage data of the computer resources as the vertical axis.

Conventional methods for displaying the usage of computer resources, the numbers or the proportions of the usage of a contain computer can be displayed and the changes with time can also be displayed. A typical display mode is a line chart or a histogram with the time as the horizontal axis. Though such display method can clearly display the usage of the computer resources at different times, it cannot directly display the following factors:

1. The correlation between the usages of two types of computer resources, for example, what is the usage of the memory under the condition that the usage of CPU is 60%.

2. The typical usages states of two types of computer resources during long periods of time, for example, whether the computer system is always under the operation condition that the

CPU usage is about 60% and the memory usage is about 30%.

### SUMMARY OF THE INVENTION

To overcome the disadvantage of the conventional method for displaying the usage of computer resources, an object of the present invention is to provide a novel method for displaying computer resources, which can display not only the usage of certain computer resource, but also the correlation between the usages of two types of computer resources, as well as the typical usage state of one type or two types of computer resources during long periods of time.

According to one aspect of the present invention, a method for displaying the usage of computer resources is provided, characterized in including the following steps:

1) selecting two types of computer resources A and B to be displayed;

2) determining the sampling time interval t for obtaining the usage data of the computer resources, and determining the longest time T for displaying each sample data;

3) simultaneously sampling the usages of the two types of computer resources A and B to be displayed at each time interval t to obtain sample data a and b which constitute a sample data pair (a, b), wherein the sample data pair is recorded in a table of length L according to the sampling time sequence and the position of the sample data pair in the table is n;

4) constructing a rectangular coordinate system for displaying a graph, using the range of possible values of the sample data a for the computer resource A as the horizontal axis and the range of possible values of the sample data b for the computer resource B as the vertical axis;

5) using the data recorded in the table, drawing dots sequentially in the rectangular coordinate system of the graph using the sample data pairs (a, b) in the table as the coordinates and using a function f(n) of the position n of the sample data pairs in the table as the colors used for drawing the dots.

Preferably, said T should be substantially greater than t, and the maximum number of valid data L is the maximum integer not more than T/t.

Preferably, when the number of the sample data pairs needed to be recorded is greater than the maximum valid length L of the table, the sample data pair recorded the earliest in the table is deleted and cleared, so as to maintain that L is invariable.

Preferably, the method is characterized in that it further includes the step:

6) clearing all the dots in the graph at each time interval t and redrawing the graph according to step 5).

According to another aspect of the invention, a device for displaying the usage of computer resources is provided, including:

Module 1 for selecting two types of computer resources A and B to be displayed;

Module 2 for determining a sampling time interval t for obtaining the usage data in the computer resources, and determining the longest time T for displaying each sample data;

Module 3 for simultaneously sampling the usages of the two types of computer resources A and B to be displayed at each time interval t, to obtain sample data a and b which constitute a sample data pair (a, b), wherein the sample data pair is recorded in a table of length L according to the sampling time sequence and the position of the sample data pair in the table is n;

Module 4 for constructing a rectangular coordinate system for displaying a graph, with the range of possible values of the sample data a for the computer resource A as the horizontal axis and the range of possible values of the sample data b for the computer resource B as the vertical axis;

Module 5 for using the data recorded in the table, sequentially drawing dots in the rectangular coordinate system of the graph using the sample data pairs (a, b) in the table as the coordinates and using a function f(n) of the position n of the sample data pairs in the table as the colors used for drawing the dots;

Preferably, said T should be substantially greater than t, and the maximum number of valid data L is the maximum integer not more than T/t.

Preferably, when the number of the sample data pairs needed to be recorded is greater than the maximum valid length L of the table, the sample data pair recorded the earliest in the table is deleted and cleared, so as to maintain that L is invariable. Preferably, the device is characterized in that it further includes:

Module 6 for clearing all the dots in the graph at each time interval t and redrawing the graph using the module 5.

### BRIEF DESCRIPTION OF THE DRAWINGS

FIG. 1 is a flow chart, which illustratively shows a method for displaying the usage of computer resources according to an embodiment of the invention.

FIG. 2 is a detailed flow chart, which illustratively shows a method for displaying the usage of computer resources according to an embodiment of the invention.

FIG. 3 is a diagram of the displaying diagram illustration according to an embodiment of the invention.

### DETAILED DESCRIPTION OF THE PREFERRED EMBODIMENTS

For more clearly understanding the above propose, features and advantages of the invention, the invention is described in detail below with reference the figures and the detailed embodiments.

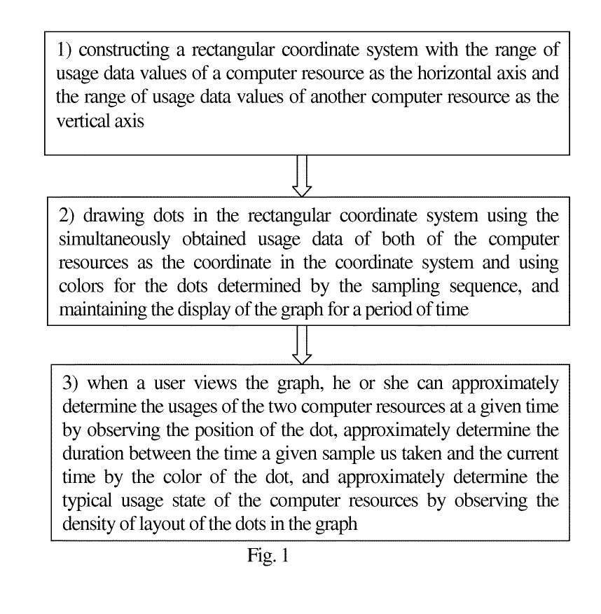

FIG. 1 is a flow chart, which illustratively shows a method for displaying the usage of computer resources according to an embodiment of the invention.

As shown in FIG. 1, said method in the embodiment includes the following steps:

1) a rectangular coordinate system is constructed with the range of usage data values of a computer resource as the horizontal axis and the range of usage data values of another computer resource as the vertical axis;

2) dots are drawn in the rectangular coordinate system using the simultaneously obtained usage data of both of the computer resources as the coordinates in the coordinate system, and using colors for the dots determined by the sampling sequence; the display of the graph is maintained for a period of time;

3) when a user views the graph, he or she can approximately determine the usages of the two computer resources at a given time by observing the position of the dot, can approximately determine the duration between the time a given sample is taken and the current time by the color of the dot, and can approximately determine the typical usage state of the computer resources by observing the density of layout of the dots in the graph.

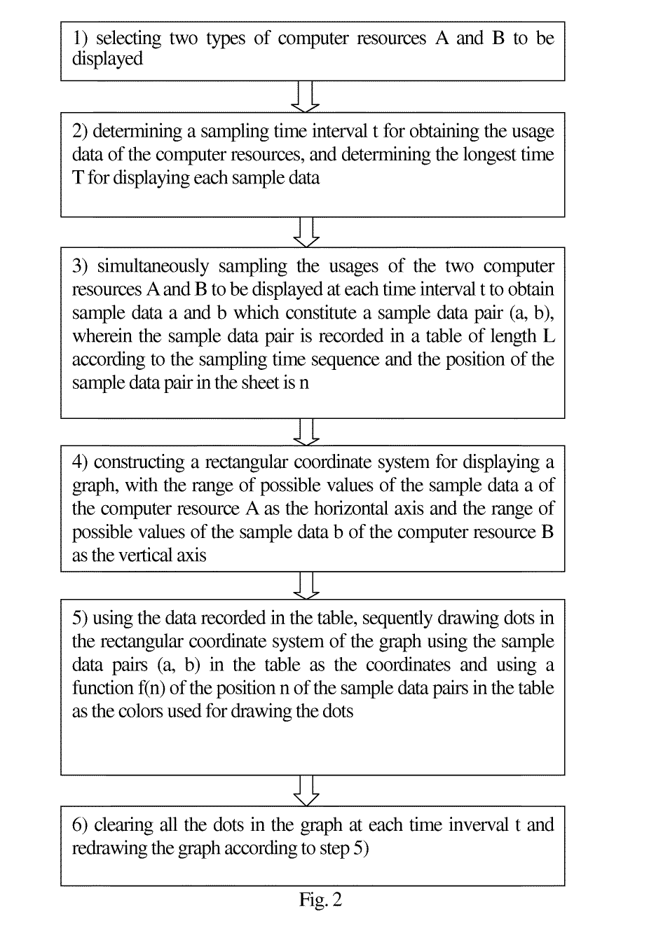

FIG. 2 is a detailed flow chart, which illustratively shows a method for displaying the usage of computer resources according to an embodiment of the invention.

As shown in FIG. 2, said method according to the embodiment includes the following steps:

1) selecting two types of computer resources A and B to be displayed;

2) determining a sampling time interval t for obtaining the usage data of the computer resources, and determining the longest time T for displaying each sample data;

Preferably, said T should be substantially greater than t, and the maximum number of valid data L is the maximum integer not more than T/t;

3) simultaneously sampling the usages of the two types of computer resources A and B to be displayed at each time interval t to obtain sample data a and b which constitute a sample data pair (a, b), wherein the sample data pair is recorded in a table of length L according to the sampling time sequence and the position of the sample data pair in the table is n;

Preferably, when the number of the sample data pairs needed to be recorded is greater than the maximum effective length L of the table, the sample data pair recorded earliest in the table is deleted and cleared, so as to maintain that L is invariable.

4) constructing a rectangular coordinate system for displaying a graph, with the range of possible values of the sample data a for the computer resource A as the horizontal axis and the range of possible values of the sample data b for the computer resource B as the vertical axis;

5) using the data recorded in the table, sequentially drawing dots in the rectangular coordinate system of the graph using the sample data pairs (a, b) in the table as the coordinates and using a function f(n) of the position n of the sample data pairs in the table as the colors used for drawing the dots.

6) all the dots in the graph are cleared at each time interval t and the graph is redrawn according to step 5).

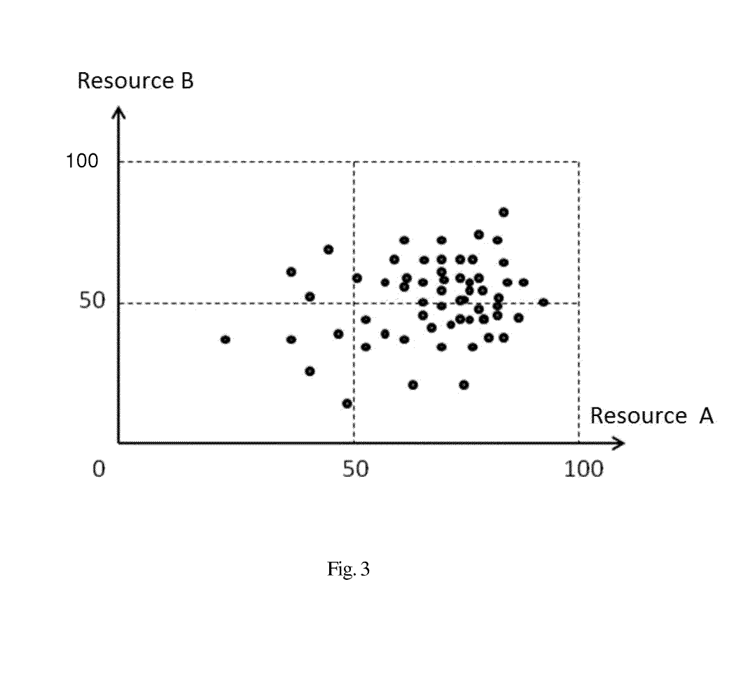

The above step 6) is optional and the update of the graph at each time interval can be achieved by step 6). The resultant graph is shown in FIG. 3.

The person skilled in the art can understand that the method in the above example can all be achieved with a computer program, so the device structure can be completely constructed in the form of corresponding device modules according to the method steps. Therefore, a device for displaying the usage of computer resource is provided in an embodiment of the invention, which includes:

Module 1 for selecting two types of computer resources A and B to be displayed;

Module 2 for determining the sampling time interval t for obtaining the usage data of the computer resources, and determining the longest time T for displaying each sample data; Preferably, said T should be substantially greater than t, and the maximum number of valid data L is the maximum integer not more than T/t;

Module 3 for simultaneously sampling the usages of the two types of computer resources A and B to be displayed at each time interval t to obtain sample data a and b which constitute a sample data pair (a, b), wherein the sample data pair is recorded in a table of length L according to the sampling time sequence and the position of the sample data pair in the table is n;

Preferably, when the number of the sample data pairs needed to be recorded is greater than the maximum effective length L of the table, the sample data pair recorded earliest in the table is deleted and cleared, so as to maintain that L is invariable;

Module 4 for constructing a rectangular coordinate system for displaying a graph, with the range of possible values of the sample data a for the computer resource A as the horizontal axis and the range of possible values of the sample data b for the computer resource B as the vertical axis;

Module 5 for using the data recorded in the table, sequentially drawing dots in the rectangular coordinate system of the graph using the sample data pairs (a, b) in the table as the coordinates and using a function f(n) of the position n of the sample data pairs in the table as the colors used for drawing the dots;

Module 6 for clearing all the dots in the graph at each time interval t and redrawing the graph using module 5.

It can be understood that the above modules are not restrictive and the person skilled in the art can optionally divide or combine the modules according to the functionality, which involves in the scope disclosed and claimed in the invention.

Though the preferable embodiments of the invention are described in detail hereinbefore, the person skilled in the art can understand that modification, addition and displacement are all possible in the spirit and the scope of the invention, such as adopting another algorithm for achieving the same purpose, adopting another different program language (for example, C, C++, Java and so on). etc., which are all in the scope defined in the claims of the invention.

What is claimed is:

1. A method for displaying the usage of computer resources, comprising the following steps:
1) selecting two types of computer resources A and B to be displayed;
2) determining a sampling time interval t for obtaining the usage data of the computer resources, and determining a longest time T for displaying the sample data;
3) sampling the usages of the two types of computer resources A and B to be displayed at each time interval t to obtain sampling result data a and b which constitute a sample data pair (a, b), wherein the sample data pair is recorded in a table of length L according to the sample time sequence and the position of the sample data pair in the table is n;
4) constructing a rectangular coordinate system for displaying a graph, with possible value range of the sample data a for the computer resource A as the horizontal axis and possible value range of the sample data b for the computer resource B as the vertical axis;
5) with the data recorded in the table, sequentially drawing dots in the rectangular coordinate system of the graph using the sample data pairs (a, b) in the table as the coordinates and using a function f(n) of a position n of the sample data pairs in the table as the colors used for drawing the dots.

2. The method of claim 1, wherein said T is substantially greater than t, and the maximum number of valid data L is the maximum integer not more than T/t.

3. The method of claim 1, wherein when the number of the sample data pairs needed to be recorded is greater than the maximum valid length T, the sample data pair recorded the earliest in the table is deleted and cleared, so as to maintain that L is invariable.

4. The method of claim 1, further comprising the step:
6) clearing all the dots in the graph at each time interval t and redrawing the graph according to step 5).

5. A device for displaying the usage of computer resources, comprising:
Module 1 for selecting two types of computer resources A and B to be displayed;
Module 2 for determining a sampling time interval t for obtaining the usage data of the computer resources, and determining the longest time T for displaying the sample data;
Module 3 for sampling the usages of the two types of computer resources A and B to be displayed at each time interval t to obtain sampling result data a and b which constitute a sample data pair (a, b), wherein the sample data pair is recorded in a table of length L according to the sample time sequence and the position of the sample data pair in the table is n;
Module 4 for constructing a rectangular coordinate system for displaying a graph, with possible value range of the sample data a for the computer resource A as the horizontal axis and possible value range of the sample data b for the computer resource B as the vertical axis;
Module 5 for using the data recorded in the table, sequentially drawing dots in the rectangular coordinate system of the graph using the sample data pairs (a, b) in the table as the coordinates and using a function f(n) of the position n of the sample data pairs in the table as the colors used for drawing the dots.

6. The device of claim 5, wherein said T is substantially greater than t, and the maximum number of valid data L is the maximum integer not more than T/t.

7. The device of claim 5, wherein when the number of the sample data pairs needed to be recorded is greater than the maximum valid length T, the sample data pair recorded the earliest in the table is deleted and cleared, so as to maintain that L is invariable.

8. The device of claim 5, further comprising:
Module 6 for clearing all the dots in the graph at each time interval t and redrawing the graph using module 5.

9. The method of claims 2, further comprising the step:
6) clearing all the dots in the graph at each time interval t and redrawing the graph according to step 5).

10. The method of claim 3, further comprising the step:
6) clearing all the dots in the graph at each time interval t and redrawing the graph according to step 5).

11. The device of claims 6, further comprising:
Module 6 for clearing all the dots in the graph at each time interval t and redrawing the graph using module 5.

12. The device of claims 7, further comprising:
Module 6 for clearing all the dots in the graph at each time interval t and redrawing the graph using module 5.
